(19) United States
(12) Patent Application Publication
(10) Pub. No.: US 2005/0149399 A1
(43) Pub. Date: Jul. 7, 2005

(54) Service server and service method

(75) Inventors: Yoshitsugu Fukunaga, Tokyo (JP); Ryo Suzuki, Tokyo (JP); Takuya Shimomura, Tokyo (JP); Tadashi Suzuki, Tokyo (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/012,279

(22) Filed: Dec. 16, 2004

(30) Foreign Application Priority Data
Dec. 18, 2003 (JP) 2003-421042
Jan. 28, 2004 (JP) 2004-20025

(51) Int. Cl. G06F 17/60; G06F 15/16

(52) U.S. Cl. 705/14; 709/219; 709/207

(57) ABSTRACT

A service server for communicating with a user terminal via a network and delivering a voice message about a picture the server has received an order to print from the user to the user terminal, comprising: a database for managing a voice message to be provided for a user and a playing condition for the voice message; an inputting device for inputting a voice message and a playing condition to be managed in the database; an access information issuing device for issuing access information to obtain the voice message via a network for the database to manage in association with the voice message and playing condition; a print instruction device for sending the picture for which the server has received an order to print with access information to a printer to record the picture and access information on the same print medium; a determination device for determining whether the current condition matches a playing condition managed in the database when the service server accessed from a user terminal by using access information recorded on the print medium; and a sending device for reading a voice message corresponding to the access information from the database and sending the voice message to the accessing user terminal when the current condition is determined to match the playing condition.

### BACKGROUND OF THE INVENTION

1. Field of the Invention

The present invention relates to a service server and a service method, specifically to a service server and a service method for delivering information on a printed picture or advertisement via a network to a user terminal such as a cellular phone.

2. Description of the Related Art

Generally, various media are used for printed advertising media, such as a handout, a town information magazine, a poster, and a signboard. A subject of advertisement to be printed on the printed advertising media also varies, including entertainment, foods and drinks, beauty, therapies, education, sports, and commercial goods.

These days, various advertising methods using Internet or cellular phones have also come into use. The advertising methods include a method for sending to general users' cellular phones an e-mail message that includes a URL (Uniform Resource Locator) for accessing a Web page on Internet, while showing advertising information on the Web page. The advertising methods also include a method for calling general users' cellular phones, and in response to the users' callbacks, offering the users voice advertising information. However, the advertisement methods may annoy users as advertisers one-sidedly provide users with advertising information regardless of the users' convenience. The methods work the other way as they sicken users, which not only frustrate the advertisement to take effect but also counteradvertise the subject of advertisement.

Other advertising methods that have also come into use include a method for advertising by attaching coupons to a printed advertising medium or putting a printed advertising medium to a plastic bag of tissue paper, in order to appeal to users as much as possible.

As an advertising method using so-called a printed photograph, a method for producing a printed photograph including advertisement by combining a template picture including advertising information with a taken picture and printing this combined picture on a sheet of paper is also proposed (See Japanese Patent Application Publication No. 2002-51204). If the printed photographs including advertisement are offered to users for free, the advertisement is received well by the users, drawing attention of the users.

Conventionally, a camera cellular phone that can take a picture of a two dimensional barcode such as QR code (trademark) printed on an advertising medium, for example, a poster or a town information magazine, decode the taken two dimensional barcode, and obtain information is proposed (See Japanese Patent Application Publication No. 2002-118680).

Also a method of printing a business card ID on a user's business cards and making a server manage each user's personal information in association with the business card ID, and in response to an access from a cellular phone or the like with the business card ID, making the server deliver personal information corresponding to the business card ID to the accessing cellular phone is proposed (see Japanese Patent Application Publication No. 2003-233712).

### SUMMARY OF THE INVENTION

Various types of advertising information are flooding around a user. Although a user often takes a look at the advertising information, the user is frustrated with unnecessary messages accounting for the most part of the information. That disturbs the user to pick up really useful information for him about a subject of advertisement of his interest. That also disturbs an advertiser to make advertisement draw attention of great many users among such flooded pieces of advertising information and provide each user with really useful information.

When an advertiser puts too many text messages on a printed advertisement medium, for example, in order to inform users of the exact details about a subject of advertisement, the advertisement usually becomes less impressive. Such advertisement does not draw attention of great many users. It troubles users to find really useful information from the miscellaneous messages. On the other hand, when an advertiser removes details from advertisement, merely emphasizing impressiveness and appearance to users, the advertisement can draw attention of great many users without informing the users of any details.

Particularly, if different services or goods are provided for users according to time, it is difficult to inform users of the exact variation over time. For example, when a movie is advertised on big posters and boards printed with a famous star's picture or a shocking scene and a large-sized message “Coming Soon!”, the advertisement can draw attention of great many users. But if details on the advertisement are not offered timely, users merely recognize that movie will be shown but still ignorant of when the movie will be shown after the first-run and which movie theater will be convenient for him. Without such exact information, the users miss the movie, or have trouble to get detailed information on the movie just before going to the movie.

When a restaurant or a store plans lunch time service or discount hours and actually provides services or goods at a discount price but the restaurant or the store fails to inform users of when and where the lunch time service or the discount hours will be provided, the advertisement effects are little and only users around by chance enjoy the event. That is actually unprofitable.

There are other cases that an advertiser plans an upscale service or providing high quality goods with limited numbers for limited period or for limited areas, without any intention of low profits and high turnover, or that an advertiser intends to appeal to users by advertising a name or a history of a provider of the service or goods, in order to draw attention of users by the provider's famousness and users' expectation for the provider. In such cases, the advertiser wants to appropriately inform users of when and where the service or the goods are provided for them or of information on the provider of the service or the goods.

Conventionally, when a user accesses a Web page by using a barcode from the user terminal such as the user's cellular phone, a separate piece of information is sent for each barcode via a network. The piece of information is usually fixed and always distributed to and displayed on an accessing user terminal. The piece of information can be obtained by anyone at anywhere. Thus, once a user recognizes the fixed information, the user is no longer excited with the information and loses an interest and hope for the information and does not access the page again.

For example, when a user accesses a Web page from a cellular phone by using a barcode printed on an advertising medium and a message “Come to theme park X!” is always delivered and played at any user terminal, even if the user is interested in the theme park X, the user is bored of such a message and never tries to access the page.

In this case, information determined only by the information provider is unconditionally sent without any regard for an accessing user's situation. Thus, information that does not match the user's needs has a good chance of being played on the user's side.

So-called a “printed photograph”, on which a picture taken by a user is printed, is provided for a user ordering to print with a satisfactory print quality. If this printed photograph can provide a user with various types of amusement in addition to just looking at a picture printed on it, the user is much more entertained. With various types of amusement stimulating a user's interests or hope, demand for the printed photograph may be increased. Demand for the business of information provider and demand for communication via a network also need to be increased.

The present invention is adapted in view of the abovementioned circumstances. An object of the present invention is to increase demand for each service and item of goods by increasing the number of accesses from a user terminal to a server via a network by using a printed medium.

Another object of the present invention is to provide entertainment for a user with a printed photograph printed with a picture taken by the user.

Yet another object of the present invention is to timely provide each user with information appropriate to the user about detailed information on each subject of advertisement displayed on each printed advertising medium such as a handout.

In order to achieve the abovementioned objects, the first aspect of the present invention is a service server for communicating with a user terminal via a network and delivering a voice message about a picture the server has received an order to print from the user to the user terminal, including a database for managing a voice message to be provided for a user and a playing condition for the voice message; an inputting device for inputting a voice message and a playing condition to be managed in the database; an access information issuing device for issuing access information to obtain the voice message via a network for the database to manage in association with the voice message and playing condition; a print instruction device for sending the picture for which the server has received an order to print with access information to a printing device to record the picture and access information on the same print medium; a determination device for determining whether the current condition matches a playing condition managed in the database when the service server accessed from a user terminal by using access information recorded on the print medium; and a sending device for reading a voice message corresponding to the access information from the database and sending the voice message to the accessing user terminal when the current condition is determined to match the playing condition.

The access information is not limited to a known URL (Uniform Resource Locator) and can be access information unique and special to each system. Access information is not limited to be printed on a print medium in a two-dimensional barcode and can be other aspects of printing at least access information is recorded on a print medium so as to be input from a user terminal. For example, an aspect of printing may be that access information is written as digital data in an IC (Integrated Circuit) tag previously formed on a print medium, or that access information is printed as a string of alphanumeric characters in character font.

The voice message is not limited to a sound data on a recorded actual human voice and can be other sound data. For example, the voice message can be sound data generated by voice synthesis, data on a recorded live music, or data on a digital music that can be represented by musical notes.

The playing condition is not limited to a condition for year, month, date, a day of the week, or season and can be other playing condition. For example, a condition for time, minuet, and place can be added to that for year, month, date, a day of the week, or season. The condition is preferably something about a user.

With this configuration, a picture the server has received an order to print and access information can be recorded on the same printed medium, whether the current condition matches a playing condition managed in the database is determined when a user accesses the service server from a user terminal by using access information recorded on the print medium, and a voice message corresponding to accessing information is sent to the user terminal when the current condition matches the playing condition, so that the user listens to the voice message from the user terminal with much interest and hope, looking forward to know the voice message, the present invention can provide a user with amusement, while increasing demand for the business of information provider, demand for communication via a network, and demand for printed photograph.

The second aspect of the present invention is the first aspect configured as the database manages setting information indicating whether the server sends a voice message common to users or a voice message specific to each user to a user terminal when the server is accessed from the user terminal, and the sending device sends a voice message common to users or a voice message specific to each user to the user terminal based on the setting information.

With this configuration, the present invention can differentiate a service with a service for sending a voice message common to users to a user terminal and a service for sending a voice message specific to each user to a user terminal according to setting previously done on a database for each order for printing or each piece of access information, which allows a user to select a desired service and allows a service provider to differentiate charges for differentiated services.

The third aspect of the present invention is the first aspect configured as the database manages a designation of a user to be provided with a voice message, such as the user's name or pet name and the sending device sends a voice message including the designation of a user to the user terminal when the server is accessed from the user terminal.

A designation of a user is not limited to the user's name (e.g., “Fujiko”) and can include both the first name and the last name or only the last name, or can be a pet name or abbreviated name. There are aspects of sending a voice message including a designation of a user who is the object of the picture (e.g., “How are you, Fujiko?”), or of sending a voice message including a designation of a user who took the picture or ordered to print the picture (e.g., “Hi, I'm Fujiko. How are you?”), or of sending a voice message including designations of both users.

With this configuration, a user can listen to a special voice message including the user's designation when the user accesses the server by using access information so that the present invention can call much more user's attention to a voice message and provides the user with entertainment of listening to the voice message.

The fourth aspect of the present invention is the third aspect configured as the database manages an anniversary for a user to be provided with a voice message such as the user's birthday, the date the user used a facility, or the date the user participated an event and the sending device sends a voice message to a user terminal when the user accesses the server from the user terminal and the current date is the user's anniversary or in a predetermined period including the user's anniversary.

The anniversary is not limited to a user's birthday, the date the user used a theme park, or the date the user participated each event and can be other anniversaries, such as a wedding anniversary or any anniversary determined by a user.

With this configuration, a user can listen to a special voice message on the user's anniversary or in a predetermined period including the anniversary when the user accesses the server from a user terminal by using access information, and the user can enjoy the voice message instead of merely looking at the printed photograph.

The fifth aspect of the present invention is the first aspect configured as the database manages various voice messages, which are different from each other for each year, month, date, day of the week, or season and the sending device sends a voice message to a user terminal, switching a voice messages according to a transition of time such as the current year, month, date, a day of the week, or season when the server is accessed from the user terminal.

The transition of time is not limited to a transition of time known to general users such as year, month, date, a day of the week, season and can be whether the current time is in the special period determined by a service provider (e.g., whether it is in a service providing period celebrating that a sport team won a championship).

With this configuration, a user can listen to a voice message switched according to a transition of time when the user accesses the service server from the user terminal by using access information and the user can enjoy the voice message instead of merely looking at the printed photograph.

The sixth aspect of the present invention is the first aspect configured as the database manages a plurality of voice messages, which are different from each other for each piece of access information, and the sending device randomly selects a voice message from the plurality of voice messages and sends the voice message to the user terminal.

With this configuration, a user can listen to a randomly played voice message when the user accesses the service server from the user terminal by using access information, and the user can enjoy the voice message instead of merely looking at the printed photograph.

The seventh aspect of the present invention is the first aspect configured as the database manages the voice messages and playing conditions by classifying them into a plurality of groups, each of which is assigned with a group identification information, the access information issuing device issues access information independently for each group, and the sending device reads a corresponding voice message from the database and sends the voice message to the user terminal on the basis of the group identification information sent from the user terminal and access information in a group indicated by the group information.

With this configuration, access information can be issued and managed for each group. For example, when a single server serves multiple facilities and the system limits the length of access information, the facilities need not divide the access information by a limited range, and the server can operate smoothly without depleting access information.

The eighth aspect of the present invention includes the steps of obtaining a picture of a user whose order for printing is received; registering a playing condition for playing a voice message to be provided for a user at a user terminal with a database; issuing access information for accessing the voice message and registering the access information with the database in association with the playing condition; sending the picture of a user whose order for printing is received and access information to a printing device and recording the picture and the access information on the same print medium; obtaining the voice message and registering the voice message with the database in association with the playing condition; determining whether the current condition matches the playing condition managed in the database when the server is accessed from a user terminal by using access information recorded on the print medium; and reading the voice message from the database and sending the voice message to the accessing user terminal when the current condition is determined to match the playing condition.

The ninth aspect of the present invention is a service server for communicating with a user terminal via a network and delivering information on a subject of advertisement for a user displayed on a printed advertising medium to the user terminal, including an inputting device for inputting planning information on the subject of advertisement; a management device for managing the planning information for each subject of advertisement; a receiving device for receiving access information input from a user terminal on the basis of a printed advertising medium recorded with access information required to obtain the planning information for each subject of advertisement from the user terminal; a delivering information preparing device for preparing delivering information including planning information by searching the planning information on a subject of advertisement corresponding to the access information after the current date and time on the basis of the access information and the date and time of receiving the access information; and a delivering device for delivering the delivering information to the user terminal.

With this configuration, delivering information including planning information after the current date and time on the subject of advertisement regarding the subject of advertisement displayed on a printed advertising medium is delivered to a user terminal when a user accesses the service server from the user terminal by using access information for each subject of advertisement recorded on a printed advertising medium, and each user can timely recognize information appropriate for the current date and time for each subject of advertisement.

In the tenth aspect of the present invention, the subject of advertisement is an amusement facility, a drinking and eating facility, a beauty facility, a therapeutic facility, an educational facility, a training facility or other facilities for providing a user with a service, a store or other facilities for providing a user with goods, a service or goods provided for a user at the facilities, or a provider of a service or goods, and the delivering information preparing device prepares delivering information including a period for providing a service or goods for a user at the facilities.

The eleventh aspect of the present invention is the tenth aspect configured as the delivering information preparing device switches contents of delivering information before and after providing a service or goods at the facilities on the basis of the current date and time.

The twelfth aspect of the present invention is the tenth aspect or the eleventh aspect configured as the receiving device obtains the present location of the user terminal from the user terminal and the delivering information preparing device prepares delivering information including planning information on the facility located near the present location on the basis of the present location.

With this configuration, planning information on the facility located near the present location of a user is delivered to the user terminal and each user can timely recognizes information on each subject of advertisement appropriate for the user's present location.

The thirteenth aspect of the present invention is the tenth aspect to the twelfth aspect configured as the printed advertising medium is what records a picture representing the facility, the service, the goods, or the provider and access information for obtaining planning information corresponding to the picture on the same sheet of paper and the delivering information preparing device prepares delivering information including planning information corresponding to the picture.

The fourteenth aspect of the present invention is a information delivering service method for delivering information on a subject of advertisement for a user displayed on a printed advertising medium to the user terminal, including the steps of obtaining planning information on the subject of advertisement; receiving access information input at a user terminal from the user terminal on the basis of a printed advertising medium recorded with access information required to obtain the planning information; preparing delivering information including planning information by searching for the planning information on a subject of advertisement corresponding to the access information after the current date and time on the basis of the access information and the date and time of receiving the access information; and delivering the delivering information to the user terminal.

According to the present invention, a printed photograph printed with a picture taken by a user provides a user with entertainment of listening to a specially provided voice message, and demand for the business of information provider, demand for communication via a network, and demand for printed photograph can be increased.

The present invention can timely provide information appropriate for each user about detailed information on each subject of advertisement displayed on each printed advertising medium such as a handout, which can increase demand for each service or each item of goods, demand for communication via a network, and demand for printed photograph.

### BRIEF DESCRIPTION OF THE DRAWINGS

FIG. 1 is a view of whole configuration of an exemplary service system including a service server of a first embodiment according to the present invention;

FIG. 2 is a block diagram illustrating an exemplary inner structure of a service server of a first embodiment according to the present invention;

FIG. 3 is a schematic diagram illustrating an exemplary printed photograph printed with access information;

FIG. 4 is a diagram illustrating a flow of processing of a service in a service system including a service server of a first embodiment according to the present invention;

FIG. 5 is a view of whole configuration of an information-delivering service system including a service server of a second embodiment according to the present invention;

FIG. 6 is a block diagram illustrating an example of a conceptual inner structure of a service server of a second embodiment according to the present invention;

FIG. 7 is a block diagram illustrating an example of a specific inner structure of a service server of a second embodiment according to the present invention;

FIG. 8 is a diagram illustrating a flow of processing of a service in a service system including a service server of a second embodiment according to the present invention;

FIG. 9 is a diagram illustrating an exemplary printed advertising medium printed with access information; and

FIG. 10 is a diagram illustrating exemplary delivering information.

### DETAILED DESCRIPTION OF THE PREFERRED EMBODIMENTS

Now, the most preferred embodiments for implementing a service server and a service method according to the present invention will be described in detail with reference to attached drawings.

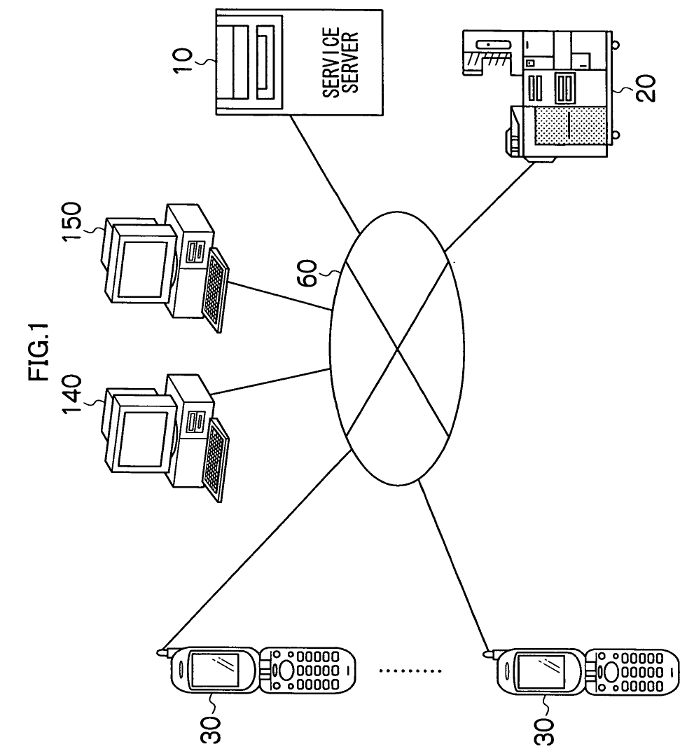

FIG. 1 is a view of whole configuration of an exemplary service system including service server 10 of a first embodiment according to the present invention.

In FIG. 1, a service system of the embodiment is mainly composed of service server 10, printing device 20, camera cellular phone (hereinafter simply referred to “cellular phone”) 30, receiving terminal 140, and registering terminal 150, each connected with network 60.

Service server 10 communicates with printing device 20, cellular phone 30, receiving terminal 140, and registering terminal 150 via network 60. Service server 10 performs various service processes such as a printing process for causing printing device 20 to produce a printed photograph according to an order for printing received at receiving terminal 140 that is described later, and a message delivering process for delivering a voice message input from registering terminal 150 to cellular phone 30 that is described later.

In order to print a picture a user ordered for printing on a sheet of paper, printing device 20 produces a printed photograph by printing access information required to obtain a voice message associated with the picture and the user's picture on the same sheet of paper. Although printing device 20 is connected with service server 10 via network 60 in FIG. 1, printing device 20 is not limited to this example and printing device 20 and service server 10 can be formed as one unit.

Cellular phone 30 is provided with a camera (not shown) that can take a picture of an object. This camera is also used for inputting a two-dimensional barcode such as QR code (Registered Trademark). Cellular phone 30 decodes the two-dimensional barcode input with a camera, accesses service server 10 via network 60 on the basis of the decoded contents (indicating access information), and obtains a voice message from service server 10 via network 60.

Receiving terminal 140 is a terminal for mainly receiving an order for printing a picture taken by a user. Specifically, receiving terminal 140 sends 1) a user's picture to be printed, 2) print specification information for specifying a print format, 3) user information on a user, and 4) a playing condition for a voice message to be provided for a user when the user accesses service server 10 from cellular phone 30 to service server 10.

Registering terminal 150 is a terminal for mainly registering a voice message. Registering terminal 150 can also register other contents delivered to cellular phone 30 along with a voice message, for example, contents including animation data of vector graphics.

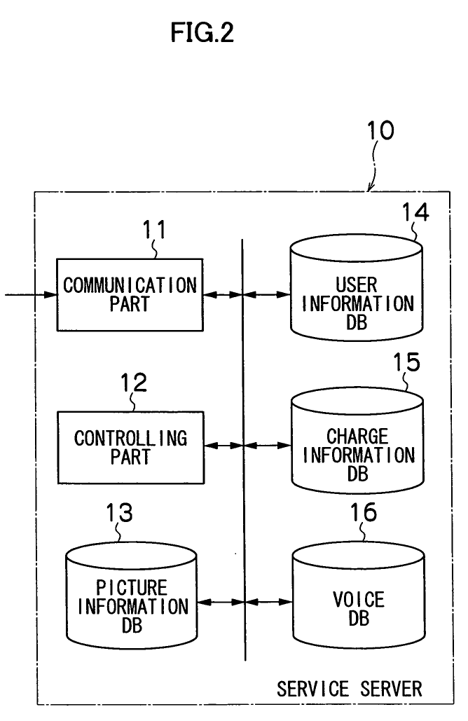

FIG. 2 is a block diagram illustrating an exemplary inner structure of service server 10. In FIG. 2, service server 10 mainly includes communication part 11, controlling part 12, and various databases 13, 14, 15, and 16. Databases 13, 14, 15, and 16 need not be in a housing of service server 10 and can be placed distant from service server 10 and connected with service server 10 via network 60 shown in FIG. 1.

Picture information database 13 manages a user's picture received at receiving terminal 140 when the user ordered for printing.

User information database 14 manages user information. User information database 14 also manages a playing condition for a voice message to be provided for a user at cellular phone 30.

User information is information on various users such as a user who ordered for printing, a user who is taken in each picture, and a user as a destination of a printed photograph. User information includes a designation of a user (e.g., a name such as “Fujiko” or a pet name) and a user's anniversary (e.g., birthday, date the user used a facility, date the user participated each event). When a produced printed photograph is delivered, user information includes information required to deliver the printed photograph or to contact a user as a destination of the printed photograph, such as a real name, a street address, and a telephone number of a user as a destination of the printed photograph.

A playing condition indicates a condition for playing each voice message, including to play a voice message corresponding to a user's birthday or a predetermined period including the user's birthday, to play a voice message corresponding to the same date of the previous use of the facility or a predetermined period including the date, and to play a voice message corresponding to the same date of the previous participation to the event or a predetermined period including the date. A playing condition can also include more detailed playing condition such as a playing condition to play a first voice message from ten days before the birthday to the day before the birthday, and to play a second voice message on the birthday. A playing condition can also be to change the voice message every day from ten days before the birthday to the birthday. A playing condition can also be to randomly change the voice message every few hours or every access from cellular phone 30 on the birthday.

Charge information database 15 manages charge information on print specification information or a user.

Print specification information is information for specifying a printed photograph to be produced at printing device 20, including the number of print or a type of print.

Voice database 16 manages a voice message to be provided for a user for each piece of access information. In addition to the voice message, voice database 16 manages other contents to be delivered to cellular phone 30 along with the voice message. For example, voice database 16 manages multimedia contents including animation data of vector graphics that represents actions of characters of well-known animation.

Communication part 11 of service server 10 can communicate with cellular phone 30 via network 60 according to HTTP (Hypertext Transfer Protocol). Specifically, when access information is input to communication part 11 from cellular phone 30 via network 60, communication part 11 outputs a voice message and contents played at cellular phone 30 with the voice message to cellular phone 30 via network 60.

A user's picture, print specification information, user information, and a playing condition for a voice message are input from receiving terminal 140 via network 60 to communication part 11 of service server 10. A voice message is input from registering terminal 150 to communication part 11 via network 60. A user's picture, print specification information, and access information are output from communication part 11 to printing device 20 via network 60.

Controlling part 12 of service server 10 has control over each part of service server 10, including information providing software for providing various types of information for a browser (browsing software) run in cellular phone 30.

Controlling part 12 of service server 10 registers a user's picture input (uploaded) from receiving terminal 140 with picture information database 13. Controlling part 12 registers user's information and a playing condition for a voice message input from receiving terminal 140 with user information database 14. Controlling part 12 also registers print specification information input from receiving terminal 140 with charge information database 15. A user's picture, print specification information, user information, a voice message, and a playing condition for a voice message are associated with each other and managed in databases 13, 14, 15, and 16. Controlling part 12 of service server 10 performs such controlling with association. For example, all or some folder names or file names are controlled to be under file management with the same name for databases 13, 14, 15, and 16 for each order (for each order for printing).

When a user's picture is input (uploaded), controlling part 12 of service server 10 issues access information for cellular phone 30 to obtain a voice message registered with voice database 16 and registers the access information with user information database 14 in association with the user's picture, print specification information, user information, a voice message, and a playing condition for a voice message for each order. As access information, a URL (Uniform Resource Locator), for example, is used. Identification information in a format specific to this service (e.g., a string of alphanumeric characters) can be used instead of a URL.

When service server 10 is accessed from cellular phone 30 by using access information recorded on a printed photograph, controlling part 12 of service server 10 determines whether the current condition (e.g., year, month, and date, or date and time) matches a playing condition managed in user information database 14. When the current condition is determined to match the playing condition, controlling part 12 of service server 10 reads a voice message corresponding to the access information from voice database 16 and sends the voice message from communication part 11 to accessing cellular phone 30.

When service server 10 is accessed from cellular phone 30 and the current date is the user's anniversary or in a predetermined period including the anniversary, controlling part 12 of service server 10 sends a voice message corresponding to access information to cellular phone 30. When service server 10 is accessed from cellular phone 30, controlling part 12 of service server 10 changes a voice message according to a transition of time such as the current year, month, date, a day of the week, or season and sends the message to cellular phone 30. When service server 10 is accessed from cellular phone 30, controlling part 12 of service server 10 sends a voice message including a user's pet name or randomly selects a voice message from a plurality of voice messages for each access and sends the message to cellular phone 30.

Whether a voice message common to users or a voice message specific to each user is sent to cellular phone 30 in response to an access from cellular phone 30 is set in user information database 14 as setting information forming a part of a playing condition for each order or each piece of access information. Based on this setting information, controlling part 12 of service server 10 sends a voice message common to users or a voice message specific to each user from communication part 11 to cellular phone.

One of various ways for issuing access information by controlling part 12 of service server 10 is to independently issue access information for each group by grouping information to be managed in a database according to setting location of receiving terminal 140 or the like. Specifically, databases 13, 14, 15, and 16 manage a user's picture, print specification information, user information, a playing condition and the like by dividing them into a plurality of groups, with each group previously assigned with group identification information, while controlling part 12 issues access information for each group. Controlling part 12 reads out a corresponding voice message from voice database 16 and sends the voice message to cellular phone 30 on the basis of group identification information sent from cellular phone 30 and access information in the group identified by the group identification information. For example, controlling part 12 of service server 10 provides a service by grouping information for each theme park.

Relationship between components of a service server according to the present invention and components of service server 10 exemplified in FIG. 2 is simply described as; an inputting device and a sending device are mainly composed of communication part 11 and controlling part 12, while an access information issuing device, a print specification device, and a determination device are composed of controlling part 12.

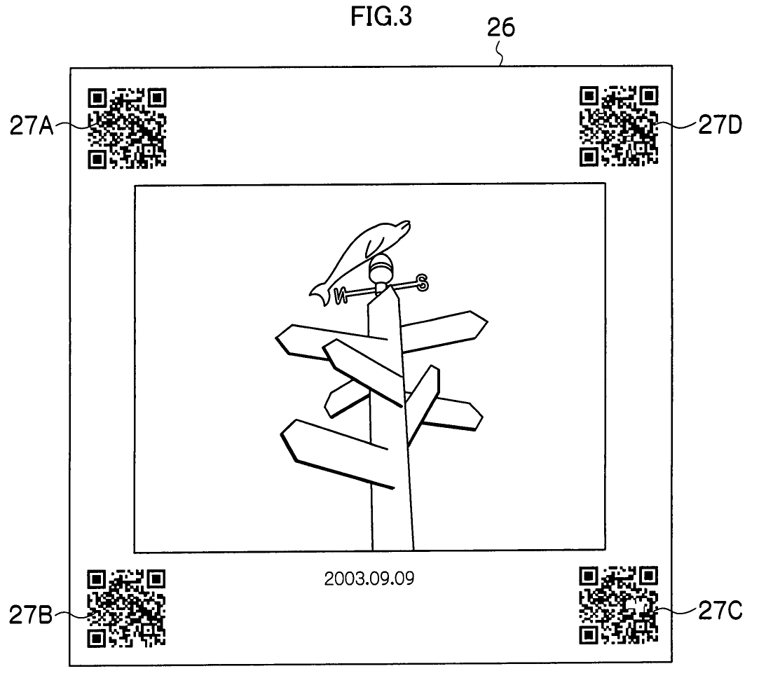

FIG. 3 shows a printed photograph 26 with four two-dimensional barcodes 27A, 27B, 27C, and 27D printed on each corner.

The four two-dimensional barcodes 27A, 27B, 27C, and 27D can be embedded with URLs for obtaining different voice messages. The barcodes can be set to deliver a different voice message from service server 10 to cellular phone 30: For example, in response to an access using a first two-dimensional barcode, service server 10 delivers “Hi, Fujiko. You can't wait for your birthday, can you?”, in response to an access using a second two-dimensional barcode, service server 10 delivers “Do you remember that exciting summer event, Fujiko?”, in response to an access using a third two-dimensional barcode, service server 10 delivers “This year's summer event starts from MM/DD”, and in response to an access using a fourth two-dimensional barcode, service server 10 delivers “anybody on his/her birthday, admission fee is discounted to half”. A voice message can be set to change according to a transition of time. The barcodes can be set to deliver a new voice message like a voice message “Happy birthday, Fujiko!” from service server 10 to cellular phone 30, if service server 10 is accessed by using a first two-dimensional barcode on the user's birthday. The barcodes can be set to deliver information on an event in a new season in a voice message to cellular phone 30 when the season changes. For example, information on Christmas season's event is delivered in a voice message in the Christmas season (from the latter half of November to December 25^{th}) to cellular phone 30.

Any one or two of four two-dimensional barcodes can be embedded with URLs for obtaining a voice message in a well-known tone, for example in a voice of an animation character of a mouse or a cat as a generally known tone of animation character's voice. The remaining two-dimensional barcodes can be embedded with URLs for accessing advertising information on a theme park or information other than URLs (e.g., character strings such as “lose”). The system can be adapted to present a user with a discount point only when the user accesses the advertisement for the first time.

In this manner, a user may be excited in using cellular phone 30 or the like to read in a two-dimensional barcode to hear the voice message like playing a scratch card lottery.

A size of a picture taken with cellular phone 30 may over a million pixels. A picture with a few pixels needs to be printed in small size to keep the picture quality. In this case, a printed photograph has big margins around, which can be effectively used by having two-dimensional barcodes printed there. The bigger the margins, the bigger two-dimensional barcode can be printed with much more information embedded on it.

Although a picture taken by a user is printed as a printed photograph shown in FIG. 3, the picture taken by a user can be printed in combination with a material picture such as a frame material. For example, a picture taken by a user can be printed in combination with a frame material including a picture representing a well-known animation character.

Other contents can be delivered to cellular phone 30 with a voice message. For example, multimedia contents including animation data of vector graphics can be delivered to cellular phone 30. When a voice message in a tone of animation character of a mouse or a cat is delivered to cellular phone 30, multimedia contents representing actions of an animation character of the mouse or the cat are delivered to cellular phone 30 and the animation is played.

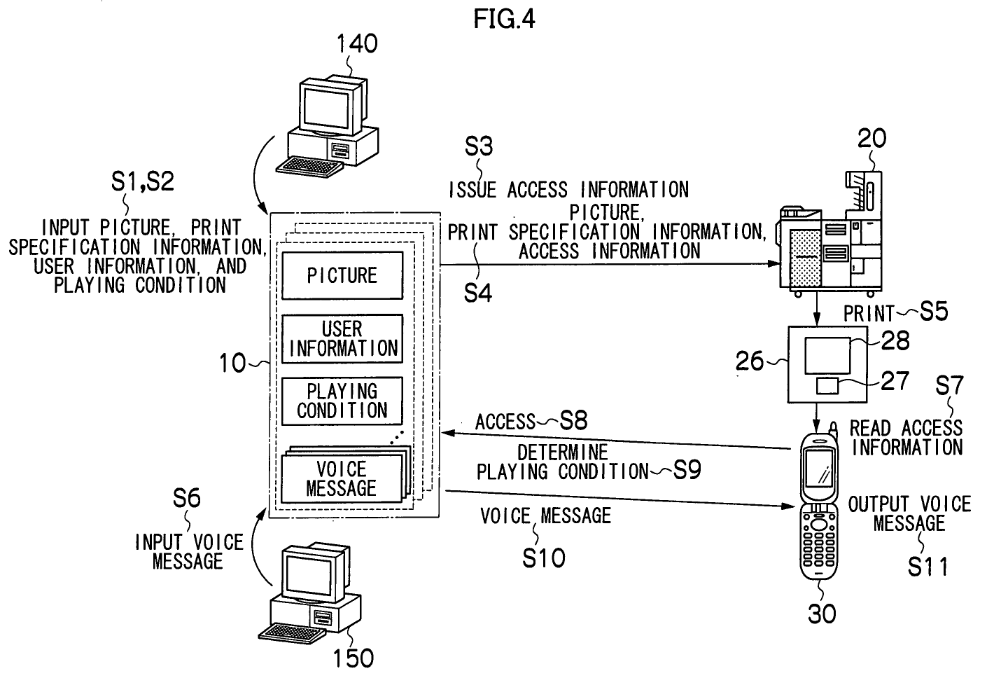

Specific flow of a service in the abovementioned service system will be described with reference to FIG. 4.

Receiving terminal 140 receives an order for printing from a user.

A user's picture is obtained and sent to service server 10 (S1). Aspects of obtaining a user's picture (picture obtaining aspects) include various aspects below.

First, an aspect of obtaining a user's picture through a recording medium such as a memory card is possible. For example, a recording medium previously recording a picture with a user's cellular phone or digital steal camera is inserted into a given slot of receiving terminal 140. Receiving terminal 140 reads a picture from the recording medium and sends the picture to service server 10.

Second, an aspect of obtaining a user's picture by directly communicating with user's camera cellular phone 30 or the like is possible. For example, receiving terminal 140 receives a picture from cellular phone 30 by directly communicating with cellular phone 30, whose memory previously records a picture, and sends the picture to service server 10.

Third, an aspect of obtaining a user's picture from a user's cellular phone 30 or the like via network 60 is possible. For example, receiving terminal 140 sends an e-mail message attached with a picture from cellular phone 30 to service server 10.

Fourth, as aspect of obtaining a user's picture by reading the picture from a film recorded with the picture with a silver-salt camera is possible.

A user's picture input into communication part 11 of service server 10 is registered with picture information database 13.

Here, it is assumed that a user's picture is obtained in a first aspect of obtaining a picture, i.e., an aspect where receiving terminal 140 reads a picture from a recording medium and sends the picture to service server 10.

In addition to the picture, print specification information, user information, and a playing condition for a voice message are obtained by receiving terminal 140 and sent to service server 10 (S2).

If print specification information is default information, the print specification information may not be obtained. User information or a playing condition may not be obtained for an entry that is previously registered with user information database 14. Aspect of selecting a playing condition include an aspect that a user who made an order for printing selects it, an aspect that an administrator of service server 10 selects it, and an aspect that a service server 10 automatically selects it.

A picture, print specification information, user information, and a playing condition are collectively called “order information”.

Service server 10 that received the order information issues access information required to obtain a voice message (S3). The access information is a URL, including a communication protocol required to obtain a voice message, a domain name of service server 10 to deliver a voice message, and information for identifying a location within a voice database storing a voice message.

In an example shown in FIG. 4, a voice message is not registered with voice database 16 when service server 10 issues access information and a voice message is registered with voice database 16 after service server 10 issued access information. The present invention is not limited to this example, and access information may be issued for a voice message previously registered with voice database 16. For example, all voice messages common to users are previously registered with voice database 16. All voice messages specific to each user to be provided for a user (e.g., “Happy birthday, Fujiko!”) can be recorded afterward when a person speaks in well-known tone as a voice of animation character. Each part of a voice message to be provided for a user (e.g., a known designation “Fujiko” and a template “Happy birthday!”) can be previously registered with voice database 16 to complete the whole (e.g., “Happy birthday, Fujiko!”) by combining each part, when an order for printing is received and the contents of a voice message is decided. The whole message can be completed by combining parts just before the message is sent to cellular phone 30.

A picture of a user whose order for printing the picture is received, print specification information, and access information are sent from service server 10 to printing device 20 (S4). The access information can be encoded to a two-dimensional barcode at service server 10 and sent to printing device 20, or can be encoded to a two-dimensional barcode at printing device 20.

Printing device 20 produces a printed photograph on the basis of a user's picture, print specification information, and access information received from service server 10 (S5). User's picture 28 and access information 27 received from service server 10 are printed on the same sheet of paper. The produced printed photograph 26 can be delivered to a destination according to a specification by a user who ordered for printing the picture, or can be handed to a user who ordered for printing the picture at the place the order for printing was received from the user.

On the other hand, a voice message is registered with voice database 16 (S6). Aspects of registering a voice message (voice message registering aspect) include various aspects below.

First, an aspect of obtaining a voice message in sound wave by picking up the sound with a voice recording microphone and registering the voice message with voice database 16 is possible. For example, a person makes order information displayed on registering terminal 150, speaks out and records a voice message according to the order information, and sends the voice message to service server 10. A voice message celebrating a birthday including a designation of a user (e.g., “Fujiko”), a voice “Happy birthday, Fujiko”, for example, is spoken recorded in well-known tone as a certain animation character.

Second, an aspect of preparing contents of a voice message by text, combining voices according to the text, and registering the combined voice message in sound wave with voice database 16 is possible. For example, voice database 16 is previously registered with a sound wave for a known designation “Fujiko” and a sound wave for a template “Happy birthday!” A voice message in a sound wave like “Happy birthday, Fujiko!” can be completed by combining the sound waves. Another method is also possible that after preparing a text “Happy birthday, Fujiko!”, sound waves for voice elements such as vowels and consonants collected from a certain person's voice are superimposed to complete a voice message in final sound waves.

Voice database 16 can be registered with contents to be sent to cellular phone 30 along with a voice message. For example, contents including animation data of vector graphics are associated with a voice message.

Next, a process for accessing service server 10 from cellular phone 30 by using access information will be described.

A user having a printed photograph 26 with access information 27 switches a mode of cellular phone 30 into reading access information mode and causes cellular phone 30 to read access information 27 on printed photograph 26 (S7). Specifically, two-dimensional barcode 27 on printed photograph 26 is input by a camera incorporated in cellular phone 30. The two-dimensional barcode 27 is decoded at cellular phone 30 and URLs required to obtain a voice message and the like can be obtained. The URLs include a communication protocol required to obtain a voice message, a domain name of service server 10 to deliver a voice message, and information for identifying a location within a voice database 16 storing a voice message and the like.

When service server 10 is accessed by using the read access information (S8), it obtains a playing condition associated with the access information from user information database 14, and determines whether the current condition matches a playing condition managed in user information database 14 (S9). For example, service server 10 determines whether the current date and time is between ten days before the user's birthday and the day before the user's birthday. For example, service server 10 also determines whether the current date is the user's birthday or not. When the current condition is determined to match a playing condition, a voice message associated with access information is read out from voice database 16 and sent to cellular phone 30 (S10). When contents other than a voice message are also to be delivered to cellular phone 30, the contents are also sent to cellular phone 30.

Cellular phone 30 outputs the voice message sent from service server 10 in sound (S11). Contents sent from service server 10 with this voice message are also played.

When the current date is between ten days before the user's birthday and the day before the user's birthday, a voice message “Hi, Fujiko. You can't wait for your birthday, can you?”, which is recorded or combined in a well-known tone as a voice of a certain animation character, is provided. When the current date is the user's birthday, a voice message “Happy birthday, Fujiko!” is provided and multimedia contents made of animation data of vector graphics representing actions of an animation character celebrating a birthday are played on a screen of cellular phone 30. The multimedia contents can be previously created in preparation for responding interactively, i.e., responding to the user's manipulation on cellular phone 30. Other voice messages for the user can follow in response to the user's manipulation on cellular phone 30.

Access information is not limited to be printed as a two-dimensional barcode near a picture, and can be embedded in the picture invisibly. In this case, access information is preferably embedded in the center of the picture.

Access information can be written on an IC tag formed on a sheet of paper. In this case, printing device 20 is provided with a writing device for writing access information on an IC tag. Cellular phone 30 is provided with a reading device for reading access information from an IC tag.

A user terminal is not limited to cellular phone 30 and can be PDA (Personal Digital Assistants).

Various pieces of additional information may be already added to a picture when a user's picture is obtained. Picture information database 13 can be adapted to manage a picture and additional information by associating them each other, and in response to an access from cellular phone 30, send the user's picture and additional information added to the picture to cellular phone 30. Additional information to a picture includes voice information recorded by a user with cellular phone 30 at the time of or after taking the picture, character information, a background music, location information indicating a location where the picture was taken, and a motion picture from which a still picture to be printed is extracted.

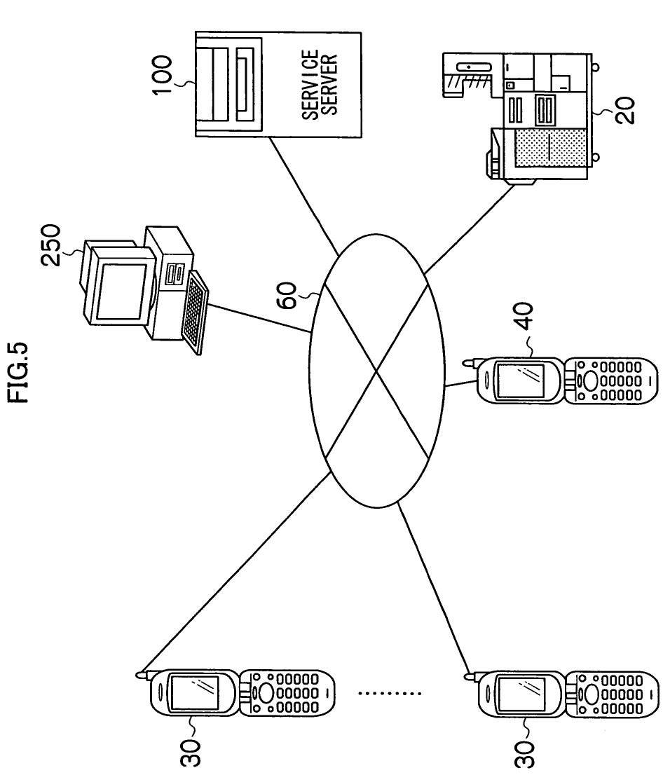

FIG. 5 is a view of whole configuration of an exemplary service system including a service server 100 of a second embodiment according to the present invention.

In FIG. 5, a service system of the embodiment is mainly composed of service server 100, printing device 20, camera cellular phones (hereinafter simply referred to “cellular phone”) 30 and 40, and information inputting terminal 250 made of a personal computer, each connected with network 60. In FIG. 5, a general user's cellular phone 30, the destination of information, and a provider's cellular phone 40 for a service provider or a provider of goods to input information are denoted separately by different reference numbers.

Service server 10 communicates with printing device 20, cellular phones 30 and 40, and information inputting terminal 250 via network 60. Service server 10 performs various service processes including a printed advertising medium producing process for causing printing device 20 to produce a printed advertising medium such as handouts; and an information delivering process for delivering information on delivering of a subject of advertisement displayed on a printed advertising medium to a general user's cellular phone 30.

Printing device 20 produces a printed advertising medium with a subject of advertisement. Although printing device 20 is connected with service server 100 via network 60 in FIG. 5, printing device 20 is not limited to this example, and printing device 20 and service server 100 can be formed as one unit.

Each of cellular phones 30 and 40 is provided with a camera (not shown) that can take a picture of an object. The camera is used for inputting a two-dimensional barcode such as QR code (Registered Trademark) in this embodiment. Each of cellular phones 30 and 40 decodes the two-dimensional barcode input by a camera, accesses service server 100 via network 60, and obtains delivering information on a subject of advertisement from service server 100.

Information inputting terminal 250 is a terminal for inputting information on a subject of advertisement to service server 100, mainly by operations for inputting planning information for each subject of advertisement.

Subjects of advertisements include a facility for providing a user with a service, a service to be provided for a user at the facility, a provider for directly providing this service for a user (attendant), a facility for providing a user with goods, goods provided for a user at the facility, a provider for actually manufacturing the goods (manufacturer).

A movie theater, a restaurant, a beauty parlor, a chiropractor's office, a school of foreign language conversation, a cooking school, a sport club, a department store, a super market are included in subjects of advertisement. Various services to be provided for a user at these facilities, such as showing of a movie, serving of foods and drinks, cutting of hairs, chiropractic practicing, teaching of a foreign language, instructing of cooking, and training of a sport, and various items of goods, such as foods and clothes are also included in subjects of advertisement.

An actual attendant such as a cook, a beautician, a chiropractor, a foreign language teacher, a cooking instructor, a sport instructor or a demonstrator who also sells the goods, a producer of primary commodity for each item of goods are included in subjects of advertisement. Famousness and anticipation for an actual attendant or actual manufacturer of goods may stimulate a user's intention of “I want to be served by that attendant” or “I want to buy goods made by that person”, which collects customers.

A printed advertising medium is a handout, a town information magazine, or a printed medium displaying other subjects of advertisement. A picture is effective in drawing users' attention, preferably printed with a still picture representing a subject of advertisement. As digital cameras and camera cellular phones have come into use, each sponsor wants to take a still picture and use it on a printed advertising medium or in delivering information instead of hiring a professional photographer. In order to serve for that purpose, the present invention is adapted that a picture or its additional information (sound information, text information, moving picture information, etc.,) is sent from information inputting terminal 250 placed at a facility or a provider's cellular phone 40 to service server 100, and the picture and the additional information is contained in a printed advertising medium or delivering information. The present invention is not limited to the case that a subject of advertisement is shown as a still picture on a printed advertising medium and can be applied to the case that a subject of advertisement is represented only by text on a printed advertising medium. The number of printed advertising media (whether a sheet of paper or a plurality of sheet to form a book) and the size (e.g., A4, a post-card size, a standard photograph size, a business card size) are not limited.

Delivering information includes planning information for each subject of advertisement. Specifically, the planning information includes when and where the service or goods are provided for users at a facility for each service or each item of goods. It also includes when a service or goods are provided for users for each provider.

The embodiment makes delivering information on when and where each service or each item of goods is provided about the services and goods general users can get after the date and time of their accessing from cellular phone 30. The embodiment makes delivering information on the place of the facility nearest to the present location of a user, actually the present location of a general user's cellular phone 30.

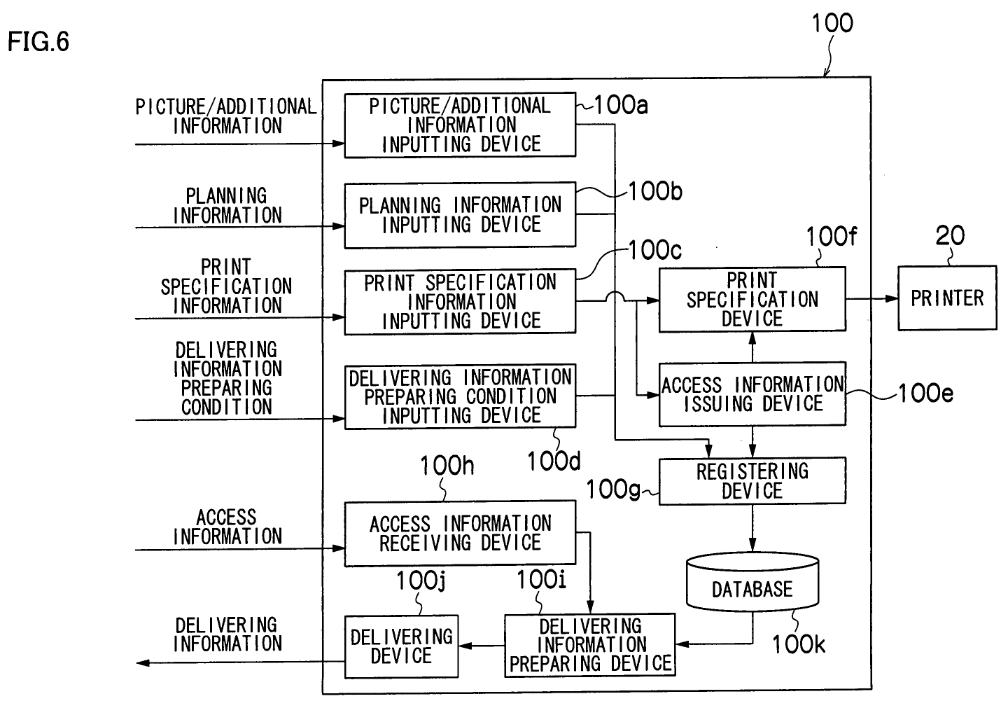

FIG. 6 is a block diagram illustrating a conceptual configuration of service server 100 of the embodiment.

In FIG. 6, service server 100 is mainly composed of picture/additional information inputting device 100a, planning information inputting device 100b, print specification information inputting device 100c, delivering information preparing condition inputting device 100d, access information issuing device 100e, print specification device 100f, registering device 100g, access information receiving device 100h, delivering information preparing device 100i, delivering device 100j, and database 100k.

Picture/additional information inputting device 100a is for inputting a still picture to be printed on a printed advertising medium and additional information to the still picture. A service system shown in FIG. 5 has two aspects; 1) an aspect of receiving the picture and its additional information from information inputting terminal 250 placed at a facility or the like, and 2) an aspect of receiving the picture and its additional information from a provider's cellular phone 40. Aspects of inputting a picture and its additional information are not limited to the above aspects and can include an aspect of selectively reading a picture and its additional information already stored in database 100k, or an aspect of reading a picture and its additional information from a removable recording medium such as a DVD (Digital Video Disk)-ROM.

Pictures to be printed on a printed advertising medium include a still picture obtained by taking a picture of a facility, if the facility is a subject of advertisement. If a service is a subject of advertisement, a still picture obtained by taking a picture of the service performed is included. If goods are a subject of advertisement, a still picture obtained by taking a picture of the goods is included. If a provider is a subject of advertisement, a still picture obtained by taking a picture of the provider is included.

Additional information is information added to a still picture to be printed on a printed advertising medium. Usage of additional information is; 1) to be recorded on a printed advertising medium with a still picture and, 2) to be included in delivering information and delivered to cellular phone 30. Additional information to be recorded on a printed advertising medium includes text information consisting of recommendation of a subject of advertisement. Additional information to be included in delivering information includes sound information, text information, a moving picture, multimedia contents made of an animation of vector graphics.

Planning information inputting device 100b is for inputting planning information on a subject of advertisement for each subject of advertisement. The service system shown in FIG. 5 has two aspects; 1) an aspect of receiving the planning information from information inputting terminal 250 placed at a facility or the like, and 2) an aspect of receiving the planning information from a provider's cellular phone 40.

Planning information on a subject of advertisement includes business days and the place for each facility. Planning information includes a schedule for showing a movie at each movie theater, when a service is provided for users for each service provided at each facility, and when an item of goods are provided for users for each item of goods provided at each facility. Planning information also includes the discount hours or happy hours, and a service concerned or an item of goods concerned. Planning information includes schedule of each service provider who actually attends a user in person or schedule of a person who actually makes the goods, for example, individual planning information such as from when to when of what day of the week the person works.

Print specification information inputting device 100c is for inputting print specification information indicating an aspect of printing a printed advertising medium. Print specification information includes the number of prints, a type of print (e.g., paper size). A service system shown in FIG. 5 has two aspects; 1) an aspect of receiving the information from information inputting terminal 250 placed at facility or the like, and 2) an aspect of receiving the information from a provider's cellular phone 40.

Delivering information preparing condition inputting device 100d is for inputting a preparing condition for preparing delivering information to be delivered to general user's cellular phone 30. In the embodiment, contents included in delivering information before a service or an item of goods is provided and contents included in delivering information after a service or an item of goods is provided are switched. For example, if a subject of advertisement is showing of a certain movie, an input preparing condition can be: Before showing the movie, delivering information indicating a synopsis and a date of nationwide first-run for the movie is prepared, and after the first-run of the movie, delivering information including a schedule for showing the movie at each movie theater nearest to the present location of a user (i.e., the present location of a general user's cellular phone 30) after the time the general user accessed from his cellular phone 30.

Access information issuing device 10e is for issuing access information for obtaining delivering information including planning information via network 60 from a general user's cellular phone 30 for each subject of advertisement when printing device 20 produces a printed advertising medium.

Access information is for example a URL, which includes a communication protocol required to obtain delivering information, a domain name of service server 100, and information for identifying a subject of advertisement. Access information is not limited to a URL and can be other access information that can identify each subject of advertisement, such as access information including identification information of a subject of advertisement.

Print specification device 100f is for sending a still picture input to picture/additional information inputting device 100a and printing data including access information issued by access information issuing device 100e to printing device 20, and instructing printing device 20 to produce a printed advertising medium on the basis of print specification information input into print specification information inputting device 10d. According to the instruction, printing device 20 records a still picture representing a subject of advertisement and access information for each subject of advertisement on the same sheet of paper by visually or physically associating them each other.

Registering device 100g is for registering a picture, its additional information, print specification information, planning information, and delivering information preparing condition with database 100k for each subject of advertisement. The picture, its additional information, print specification information, planning information, and delivering information preparing condition are associated with access information issued from access information issuing device 100h (described later) and registered with database 100k.

When additional planning information for each subject of advertisement is input in planning information inputting device 100b, the additional planning information is registered with database 100k in association with already input planning information for each subject of advertisement. When a change of planning information for each subject of advertisement is input in planning information inputting device 100b, already input planning information is overwritten with the changed planning information or the change is registered with database 100k in association with already input planning information for each subject of advertisement.

When access information on a printed advertising medium is input to a general user's cellular phone 30, access information receiving device 100h receives the access information from the cellular phone 30 or the like.

Delivering information preparing device 100i is, based on access information received from a general user's cellular phone 30 and the date and time the access information was received, for searching database 100k for planning information on a subject of advertisement corresponding to the access information after the date and time and preparing delivering information including the searched planning information. When the present location of a general user's cellular phone 30 is detected, delivering information preparing device 100i searches database 100k for planning information on the present location based on the present location (the present location of the user) and prepares delivering information including the searched planning information.

Delivering device 100j is for delivering the delivering information prepared by delivering information preparing device 100i to a general user's cellular phone 30.

Database 100k is for storing a picture, its additional information, planning information, print specification information, and delivering information preparing condition in association with access information. A picture, its additional information, planning information, print specification information, and delivering information preparing condition are managed by grouping for each sponsor.

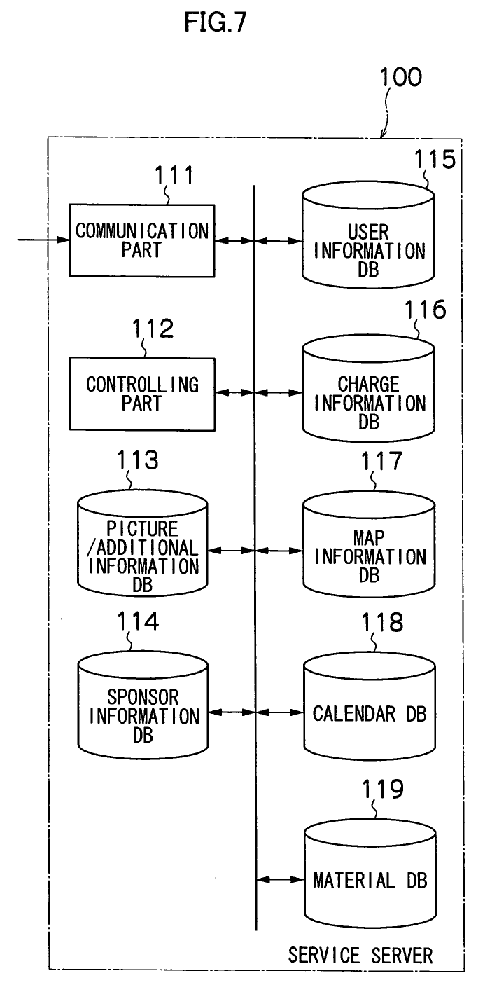

FIG. 7 is a block diagram illustrating a specific example of an inner structure of a service server 100. In FIG. 7, a service server 100 is mainly composed of communication part 111 communicating with cellular phones 30 and 40 or information inputting terminal 250 via network 60, controlling part 112 made of CPU (Central Processing Unit), picture/additional information database 113, sponsor information database 114, user information database 115, charge information database 116, map information database 117, calendar database 118, and material database 119. Databases 113 and 119 need not to be in a housing of service server 100 and can be placed distant from service server 100 and connected with service server 100 via network 60 shown in FIG. 5.

Communication part 111 is adapted to receive a picture, its additional information, planning information, print specification information, and delivering information preparing condition from information inputting terminal 250 or a provider's cellular phone 40 shown in FIG. 5 via network 60. Communication part 111 can communicate with a general user's cellular phone 30 according to HTTP (Hypertext Transfer Protocol) and receives access information from a general user's cellular phone 30 via network 60 and sends delivering information corresponding to the access information to the general user's cellular phone 30.

Picture/additional information database 113 manages a picture and its additional information for each subject of advertisement. Sponsor information database 114 manages planning information for each subject of advertisement and other information on a sponsor. User information database 115 manages the number of accesses and other information on a general user. Charge information database 116 manages print specification information and other information on charge for the sponsor. Map information database 117 manages map information, particularly map information on each facility and an area around there. Calendar database 118 manages calendar information such as year, month, date, a day of the week, and holidays. Material database 119 manages material for printing data to be printed on a printed advertising medium and material for delivering information.

Relationship between components of a service server 100 in a specific example shown in FIG. 7 and components of service server 100 in a conceptual structure shown in FIG. 6 is simply described as; picture/additional information inputting device 100a, planning information inputting device 100b, print specification information inputting device 100c, delivering information preparing condition inputting device 100d, and access information receiving device 100h are mainly formed by communication part 111, delivering device 100j is mainly formed by communication part 111 and controlling part 112, and access information issuing device 10e, print specification device 100f, registering device 100g and delivering information preparing device 100i are mainly formed by controlling part 112.

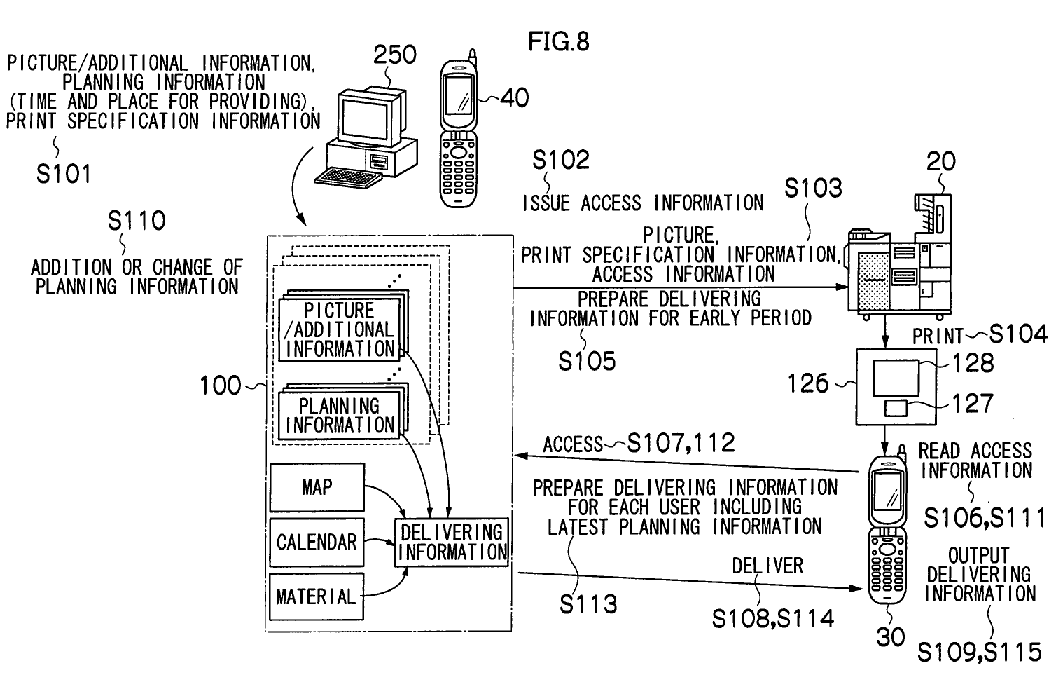

A flow of specific processes in the information delivering service system described above will be described mainly with reference to FIG. 8.

First, a sponsor (advertiser) inputs information for producing a printed advertising medium and information for preparing delivering information for early period delivered before providing the service or the item of goods into service server 100 (S101).

Information for producing a printed advertising medium includes a still picture to be printed on a printed advertising medium and print specification information indicating a print format for a printed advertising medium. For example, for the purpose of advertising movie showing, the information is a still picture representing a famous star appearing in the movie and a title of the movie, and print specification information indicating the paper size, the layout, and the number to be printed.

Information for preparing delivering information for early period includes detailed information showing brief description of a service or an item of goods provided for a user. For example, for the purpose of advertising movie showing, the information is text information showing brief description of the movie (the cast, outline of the story, etc.) and a moving picture for the trailer. Delivering information for early period can be input as it is.

Planning information for early period is input in service server 100. For example, for the purpose of advertising movie showing, the information is the name, place, telephone number for contact of each movie theater to show the movie and nationwide first-run day. Planning information already registered in database 100k needs not be input.

Delivering information preparing condition is input in service server 100. For example, when a subject of advertisement is showing of a certain movie, a preparing condition is input as below: Before the first-run of the movie, prepare delivering information including a brief description of the movie to be shown and a moving picture for the trailer, and after the first-run of the movie, prepare delivering information including a time schedule for the movie at the movie theater nearest to the present location of a user (i.e., the present location of a general user's cellular phone 30) after the time the general user accessed the service server 100 from his cellular phone 30.

Information for producing a printed advertising medium or information for preparing delivering information for early period may be input to service server 100 from information inputting terminal 250 placed at a facility or from cellular phone 40 owned by a provider.

The input picture, its additional information (text information, a moving picture, etc.), planning information, print specification information, and a delivering information preparing condition are managed in database 100k for each subject of advertisement. Delivering information for early period is previously prepared based on a delivering information preparing condition and registered with database 100k. If delivering information for early period is input in service server 100 as it is, the information needs not be prepared again and the information in service server 100 is registered with database 100k as it is.

Service server 100 issues access information necessary for a general user's cellular phone 30 to obtain delivering information including planning information from service server 100 for each subject of advertisement (S102). The issued access information is managed in database 100k in association with a picture, its additional information, planning information, print specification information, a delivering information prepared condition, and delivering information for early period.

A still picture to be printed on a printed advertising medium, print specification information, and access information are sent from service server 100 to printing device 20 (S103). Access information can be encoded into a two-dimensional barcode at service server 100 and sent to printing device 20, or encoded into a two-dimensional barcode at printing device 20.

Printing device 20 produces a printed advertising medium 26 based on a picture, print specification information, and access information received from service server 100 (S104). Access information is printed in two-dimensional barcode 127 on the same sheet of paper as picture 128.

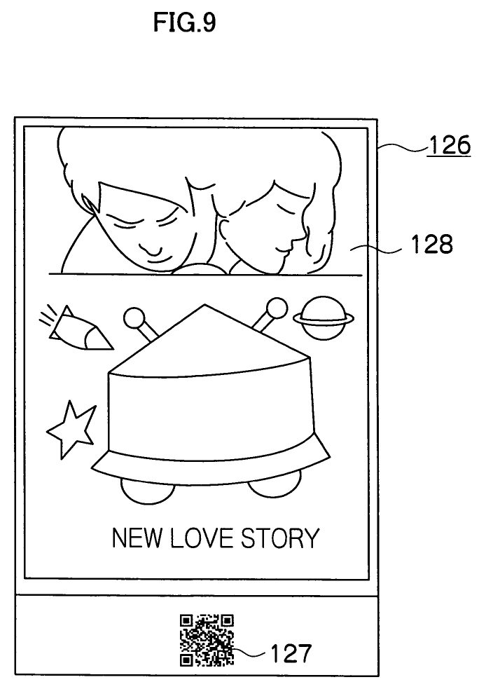

Printed advertising medium 126 shown in FIG. 9 is for advertising movie showing, having a still picture 128 representing famous stars appearing in the movie, the movie title and the like and two-dimensional barcode 127 indicating access information printed on it.

Printed advertising medium 126 produced by the printing device is handed to the sponsor who ordered to print, or delivered to a predetermined destination specified by the sponsor who ordered to print. Then, printed advertising media 126 are widely distributed to general users.

First, information delivery before the service or item of goods is provided will be described.

A general user, the destination of printed advertising medium 126, sets his cellular phone 30 to access information reading mode and has cellular phone 30 read two-dimensional barcode 127 on printed advertising medium 126 (S106). Cellular phone 30 decodes two-dimensional barcode 127 and accesses service server 100 using the decoded access information (S107). Service server 100 identifies a subject of advertisement corresponding to the access information, obtains delivering information for early period corresponding to the subject of advertisement from database 100k, and delivers the delivering information for early period to the general user's cellular phone 30 (S108).

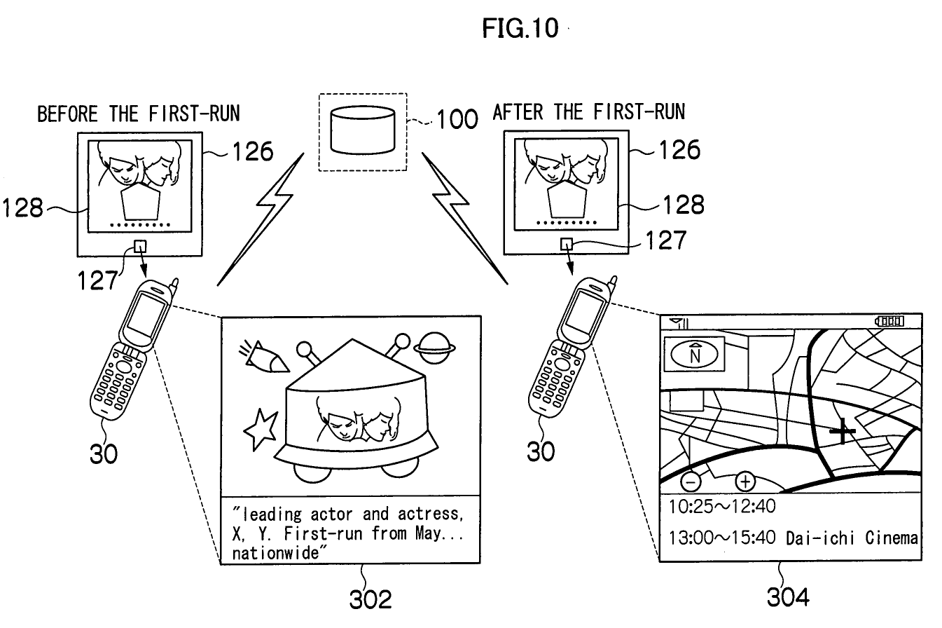

FIG. 10 shows an example of information delivery for advertising a movie. When a user has cellular phone 30 read two-dimensional barcode 127 on printed advertising medium 126 and access service server 100 before the first-run of the movie, delivering information for early period 302 including text information showing a brief description of the movie (“leading actor and actress, X, Y. First-run from May . . . nationwide”) and a moving picture as the trailer is delivered to a general user's cellular phone 30.

Delivering information for early period delivered from service server 100 to cellular phone 30 is output from cellular phone 30 (S109). As a screen of cellular phone 30 is usually small, service server 100 may prepare the delivering information to superimpose a brief description on a moving picture or to display a brief description before or after playing the moving picture.

An actual facility to provide a service or an item of goods for users generally does not decide its detailed schedule until the first day of providing the service or the goods approaches. In addition, the facility adds or changes planning information after it started providing the services or the goods. Specifically, the time, the place, and the providers of the service or the goods may be changed. For example, in case of a schedule of movie showing, each movie theater does not decide its detailed schedule until the first-run day approaches. A schedule may differ between the day before holiday or on Saturday and weekday (such as showing overnight). The moving showing period may be prolonged or shortened after the first-run at each movie theater.

Such addition or change of planning information is input to service server 100 (S110). Specifically, addition or change of planning information is sent from information inputting terminal 250 placed at a facility or provider's cellular phone 40 to service server 100 via network 60. Service server 100 registers the addition or change of planning information with database 100k in association with access information for each subject of advertisement.

Next, information delivery after a service or an item of goods is provided will be described.

A user, the destination of printed advertising medium 126, sets his cellular phone 30 to access information reading mode and has cellular phone 30 read two-dimensional barcode 127 on printed advertising medium 126 (S111). Cellular phone 30 decodes two-dimensional barcode 127 and accesses service server 100 using the decoded access information (S112). Service server 100 identifies a subject of advertisement corresponding to the access information, obtains the latest planning information corresponding to the subject of advertisement from database 100k, and prepares delivering information including this latest planning information (S113).

If cellular phone 30 can obtain its present location by GPS (Global Positioning System) function, location information indicating the present location of cellular phone 30 (i.e., the present location of the user) and access information are sent from cellular phone 30 to service server 100. Other methods including a method that a user inputs the present location from cellular phone 30 or a method that a base station (not shown) directly communicating with cellular phone 30 detects the present location of cellular phone 30 are possible. Service server 100 searches database 100k for planning information on a facility nearest to the present location after the current date and time and prepares delivering information including the searched planning information. The prepared delivering information is delivered from service server 100 to cellular phone 30 (S114).

FIG. 10 shows an example of information delivery for advertising movie showing. When a user has cellular phone 30 read two-dimensional barcode 127 on printed advertising medium 126 after the first-run of the movie and cellular phone 30 accesses service server 100, delivering information 304 indicating the location of a movie theater nearest to the present location of cellular phone 30 (e.g., “Dai-ichi Cinema”) and the time schedule for movie showing on the day is delivered to cellular phone 30 and output on cellular phone 30 (S115). For example, cellular phone 30 displays from 10.25 to 12.40 and from 13.00 to 15.20 as showing times on the day after the current time. Cellular phone 30 may also be adapted to display showing times after the user's arrival to the movie theater by calculating time required for getting from the present location to the movie theater.

Access information is not limited to be printed on a printed medium as two-dimensional barcode and can be embedded in a printed medium invisibly.

Access information can be written on an IC tag formed on a sheet of paper. In this case, printing device 20 is provided with a writing device for writing access information on an IC tag. Cellular phone 30 is provided with a reading device for reading access information from an IC tag.

A user terminal is not limited to a cellular phone and can be a PDA (Personal Digital Assistants).

The present invention is not limited to the examples shown in the drawings and the examples described as embodiments and can be changed or improved, if required, according to the spirit of the present invention.

1. A service server for communicating with a user terminal via a network and delivering a voice message about a picture the server has received an order to print from the user to the user terminal, comprising:
a database for managing a voice message to be provided for a user and a playing condition for the voice message;
an inputting device for inputting a voice message and a playing condition to be managed in the database;
an access information issuing device for issuing access information to obtain the voice message via a network for the database to manage in association with the voice message and playing condition;
a print instruction device for sending the picture for which the server has received an order to print with access information to a printer to record the picture and access information on the same print medium;
a determination device for determining whether the current condition matches a playing condition managed in the database when the service server accessed from a user terminal by using access information recorded on the print medium; and
a sending device for reading a voice message corresponding to the access information from the database and sending the voice message to the accessing user terminal when the current condition is determined to match the playing condition.

2. The service server according to claim 1, wherein the database manages setting information indicating whether the server sends a voice message common to users or a voice message specific to each user to the user terminal when the server is accessed from the user terminal; and
wherein the sending device sends a voice message common to users or a voice message specific to each user to the user terminal based on the setting information.

3. The service server according to claim 1, wherein the database manages a designation of a user to be provided with a voice message, such as the user's name or pet name; and
wherein the sending device sends a voice message including the designation of a user to the user terminal when the server is accessed from the user terminal.

4. The service server according to claim 3, wherein the database manages an anniversary for a user to be provided with a voice message such as the user's birthday, the date the user used a facility, or the date the user participated an event; and
wherein the sending device sends a voice message to a user terminal when the server is accessed from the user terminal and the current date is the user's anniversary or in a predetermined period including the user's anniversary.

5. The service server according to claim 1, wherein the database manages various voice messages, which are different from each other for each year, month, date, day of the week, or season; and
the sending device sends a voice message to a user terminal, switching a voice message according to a transition of time such as the current year, month, date, a day of the week, or season when the server is accessed from the user terminal.

6. The service server according to claim 1, wherein the database manages a plurality of voice messages, which are different from each other for each piece of access information; and
the sending device randomly selects a voice message from the plurality of voice messages and sends the voice message to the user terminal.

7. The service server according to claim 1, wherein the database manages the voice messages and playing conditions by classifying the voice messages and playing conditions into a plurality of groups, each of which is assigned with a group identification information;
the access information issuing device issues access information independently for each group; and
the sending device reads a corresponding voice message from the database and sends the voice message to the user terminal on the basis of the group identification information sent from the user terminal and access information in a group indicated by the group identification information.

8. A service method, comprising the steps of:
obtaining a picture of a user whose order for printing is received;
registering a playing condition for playing a voice message to be provided for a user at a user terminal with a database;
issuing access information for accessing the voice message and registering the access information with the database in association with the playing condition;
sending the picture of a user whose order for printing is received and access information to a predetermined printer and recording the picture and the access information on the same print medium;
obtaining the voice message and registering the voice message with the database in association with the playing condition;
determining whether the current condition matches the playing condition managed in the database when the server is accessed from a user terminal by using access information recorded on the print medium; and
reading the voice message from the database and sending the voice message to the accessing user terminal when the current condition is determined to match the playing condition.

9. A service server for communicating with a user terminal via a network and delivering information on a subject of advertisement for a user displayed on a printed advertising medium to the user terminal, comprising:
an inputting device for inputting planning information on the subject of advertisement;
a management device for managing the planning information for each subject of advertisement;
a receiving device for receiving access information input from a user terminal on the basis of a printed advertising medium recorded with access information required to obtain the planning information for each subject of advertisement from the user terminal;
a delivering information preparing device for preparing delivering information including planning information by searching the planning information on a subject of advertisement corresponding to the access information after the current date and time on the basis of the access information and the date and time of receiving the access information; and
a delivering device for delivering the delivering information to the user terminal.

10. The service server according to claim 9, wherein the subject of advertisement is an amusement facility, a drinking and eating facility, a beauty facility, a therapeutic facility, an educational facility, a training facility or other facilities for providing a user with a service, a store or other facilities for providing a user with goods, a service or goods provided for a user at the facilities, or a provider of a service or goods; and
wherein the delivering information preparing device prepares delivering information including a period for providing a service or goods for a user at the facilities.

11. The service server according to claim 10, wherein the delivering information preparing device switches contents of delivering information before and after providing a service or goods at the facilities on the basis of the current date and time.

12. The service server according to claim 10, wherein the receiving device obtains the present location of the user terminal from the user terminal; and
the delivering information preparing device prepares delivering information including planning information on the facility located near the present location on the basis of the present location.

13. The service server according to claim 11, wherein the receiving device obtains the present location of the user terminal from the user terminal; and
the delivering information preparing device prepares delivering information including planning information on the facility located near the present location on the basis of the present location.

14. The service server according to claims 10, wherein the printed advertising medium is what records a picture representing the facility, the service, the goods, or the provider and access information for obtaining planning information corresponding to the picture on the same sheet of paper; and
wherein the delivering information preparing device prepares delivering information including planning information corresponding to the picture.

15. The service server according to claims 12, wherein the printed advertising medium is what records a picture representing the facility, the service, the goods, or the provider and access information for obtaining planning information corresponding to the picture on the same sheet of paper; and
wherein the delivering information preparing device prepares delivering information including planning information corresponding to the picture.

16. The service server according to claims 13, wherein the printed advertising medium is what records a picture representing the facility, the service, the goods, or the provider and access information for obtaining planning information corresponding to the picture on the same sheet of paper; and
wherein the delivering information preparing device prepares delivering information including planning information corresponding to the picture.

17. An information delivering service method for delivering information on a subject of advertisement for a user displayed on a printed advertising medium to the user terminal, comprising the steps of:
obtaining planning information on the subject of advertisement;
receiving access information input at a user terminal from the user terminal on the basis of a printed advertising medium recorded with access information required to obtain the planning information;
preparing delivering information including planning information by searching for the planning information on a subject of advertisement corresponding to the access information after the current date and time on the basis of the access information and the date and time of receiving the access information; and
delivering the delivering information to the user terminal.
